(19) United States
(12) Patent Application Publication
(10) Pub. No.: US 2018/0164122 A1
(43) Pub. Date: Jun. 14, 2018

(54) Electronic Control Device for Controlling a Drone, Related Drone, Controlling Method and Computer Program

(71) Applicant: Parrot Drones, Paris (FR)

(72) Inventors: Ariel Rimoux, Paris (FR); Fabien Remond, L'Hay Les Roses (FR); Cédric Niquin, Suresnes (FR)

(21) Appl. No.: 15/835,691

(22) Filed: Dec. 8, 2017

(30) Foreign Application Priority Data
Dec. 9, 2016 (FR) 16 62264

(51) Int. Cl. G01C 23/00; G08G 5/00; B64C 39/02; G01C 5/00

(52) U.S. Cl. CPC G01C 23/00; G08G 5/0069; B64C 2201/146; G01C 5/00; B64C 2201/127; B64C 39/024

(57) ABSTRACT

An electronic device for controlling a drone that comprises:
a first acquisition module configured for acquiring a succession of images of a terrain overflown by the drone and taken by an image sensor equipping the drone;
a second acquisition module configured for acquiring a measured ground speed via a measuring device equipping the drone, and for acquiring a measured altitude of the drone with respect to a reference level;
a calculation module configured for calculating an altitude of the drone with respect to the terrain, based on the acquired measured ground speed and an optical flow algorithm applied to the acquired images; and
a recalibration module configured for correlating the altitude calculated with respect to the terrain with the altitude measured with respect to the reference level.

### CROSS-REFERENCE TO RELATED APPLICATIONS

This application is a U.S. non-provisional application claiming the benefit of French Application No. 16 62264, filed on Dec. 9, 2016, which is incorporated herein by reference in its entirety.

### FIELD

The present invention relates to an electronic device for controlling a drone. The electronic device comprises a first acquisition module configured for acquiring a succession of images of a terrain overflown by the drone, and taken by an image sensor equipping the drone, and a second acquisition module configured for acquiring a measured ground speed via a measuring device equipping the drone.

The electronic device further comprises a calculation module configured for calculating an altitude of the drone with respect to the terrain, based on an optical flow algorithm applied to the acquired images and the acquired measured ground speed.

The invention also relates to a drone comprising an image sensor and such an electronic control device.

The invention also relates to a method for controlling the drone.

The invention also relates to a non-transitory computer-readable medium including a computer program comprising software instructions which, when executed by a computer, implement such a control method.

The invention relates to the field of drones, i.e. remote-controlled motorized flying devices. The invention applies, in particular, to fixed-wing drones, while also applying to other types of drones, for example rotary wing drones, such as quadricopters.

### BACKGROUND

It is known, from the article “Determining Altitude AGL Using Optical Flow” by Jonathan Price, that a drone comprises a control device of the aforementioned type. The drone is a fixed-wing drone, which is controllable by using a portable electronic device, such as a smartphone or an electronic tablet.

The electronic device is configured for acquiring a succession of images of a terrain overflown by the drone, and taken by an image sensor equipping the drone, and also a measured ground speed, provided by a measuring device equipping the drone, such as a satellite positioning system, also known as a Global Positioning System (GPS).

The control device is configured for calculating an altitude of the drone with respect to the terrain, based on an optical flow algorithm applied to the acquired images and the measured ground speed.

The altitude thus calculated verifies the following equation:

Altitude=Vₛₒₗ_{_}ₘₑₛ/(Optical Flow−Pitch Rate)
where Vₛₒₗ_{_}ₘₑₛ represents the measured ground speed provided by the measuring device, such as the GPS system;
optical flow represents the optical flow calculated by the calculation module, and
pitch rate represents a pitch rate of the drone, provided by a gyroscope equipping the drone.

However, the altitude thus calculated is not always very reliable, and the operation of the drone reflects this.

### SUMMARY

The object of the invention is therefore to propose an electronic control device that calculates more reliably the altitude of the drone with respect to the terrain overflown, and thus allows reducing possible jerkiness during the operation of the drone, in particular in the landing phase.

For this purpose, the subject-matter of the invention is an electronic control device of the aforementioned type, wherein the second acquisition module is configured for further acquiring an altitude of the drone measured with respect to a reference level, and the device further comprises a recalibration module configured for correlating the altitude calculated with respect to the terrain with the altitude measured with respect to the reference level.

The electronic control device according to the invention thus allows recalibrating the altitude of the drone calculated with respect to the terrain, by making a correlation between the altitude calculated with respect to the terrain and the altitude measured with respect to the reference level. The reference level is, for example, sea level, and the altitude measured with respect to sea level is, for example, obtained via a pressure sensor.

The measured ground speed is, for example, provided by a satellite positioning device, also called GNSS (Global Navigation Satellite System), such as a GPS (Global Positioning System) receiver, and/or by an inertial sensor.

The altitude with respect to the terrain, thus calculated and recalibrated, is then more reliable, and is particularly useful, especially in the landing phase, to better predict the approach to the ground, and to anticipate the moment when the control device has to control the drone's pitch, i.e. an increase in its pitch, in order to land.

According to other advantageous aspects of the invention, the electronic control device comprises one or more of the following features, taken separately or in any technically possible combination:
the recalibration module is further configured for estimating a current altitude with respect to the terrain from a current altitude measured with respect to the reference level, and from a previous altitude calculated with respect to the terrain that has been correlated with a previous altitude measured with respect to the reference level,
preferably in the event of a failure, at least temporary, of calculation of the altitude with respect to the terrain based on the optical flow algorithm;
the first acquisition module is further configured for calculating a first indicator as a function of an image gradient, the calculation module being configured for calculating the altitude of the drone with respect to the terrain only when the value of the first indicator is greater than a first threshold;
the recalibration module is further configured for calculating a second indicator inversely proportional to the first indicator and for correlating the altitude calculated with respect to the terrain with the altitude measured with respect to the reference level, only when the value of the second indicator is less than a second threshold;
the reference level is sea level, and the altitude measured with respect to sea level is obtained via a pressure sensor;
the second acquisition module is configured for further acquiring an altitude of the drone measured with respect to the terrain, and the device further comprises a control module configured for controlling an attitude of the drone as a function of an altitude of the drone, the control module being configured for calculating flight instructions corresponding to said attitude;
when the value of the altitude measured with respect to the terrain is greater than a first predefined altitude threshold, the control module is configured for controlling the attitude of the drone as a function of the altitude measured with respect to the terrain and acquired by the second acquisition module, and
when the value of the altitude measured with respect to the terrain is less than the first predefined altitude threshold, the control module is configured for controlling the attitude of the drone in addition, as a function of the altitude with respect to the terrain calculated by the calculation module;
when the value of the altitude measured with respect to the terrain is less than a second predefined threshold altitude, the control module is configured for controlling the pitch of the drone at a value greater than a predefined minimum landing pitch.

The subject-matter of the invention is also a drone comprising an image sensor configured for taking a succession of images of a terrain overflown by the drone, and an electronic control device, wherein the electronic control device is as defined above.

The subject-matter of the invention is also a method for controlling a drone comprising an image sensor, wherein the method is implemented by an electronic device and comprises:
the acquisition of a succession of images taken by the image sensor of a terrain overflown by the drone,
the acquisition of a measured ground speed provided by a measuring device equipping the drone, and
the calculation of an altitude of the drone with respect to the terrain, based on the acquired measured ground speed and an optical flow algorithm applied to the images acquired,
the acquisition of an altitude of the drone measured with respect to a reference level, and
the correlation of the altitude calculated with respect to the terrain with the altitude measured with respect to the reference level.

The invention also relates to a non-transitory computer-readable medium including a computer program comprising software instructions which, when executed by a computer, implement a method as defined above.

### BRIEF DESCRIPTION OF THE DRAWINGS

These features and advantages of the invention will appear more clearly upon reading the description which follows, given solely by way of a non-limiting example, and with reference to the appended drawings, wherein:

FIG. 1 shows a schematic representation of a drone comprising an electronic control device according to the invention; and

FIG. 2 shows a flowchart of a control method according to the invention.

### DETAILED DESCRIPTION

In the following of the description, the expression “substantially constant” means a value plus or minus 10%, i.e. with a variation of at most 10%, more preferably as a value plus or minus 5%, i.e. with a variation of at most 5%.

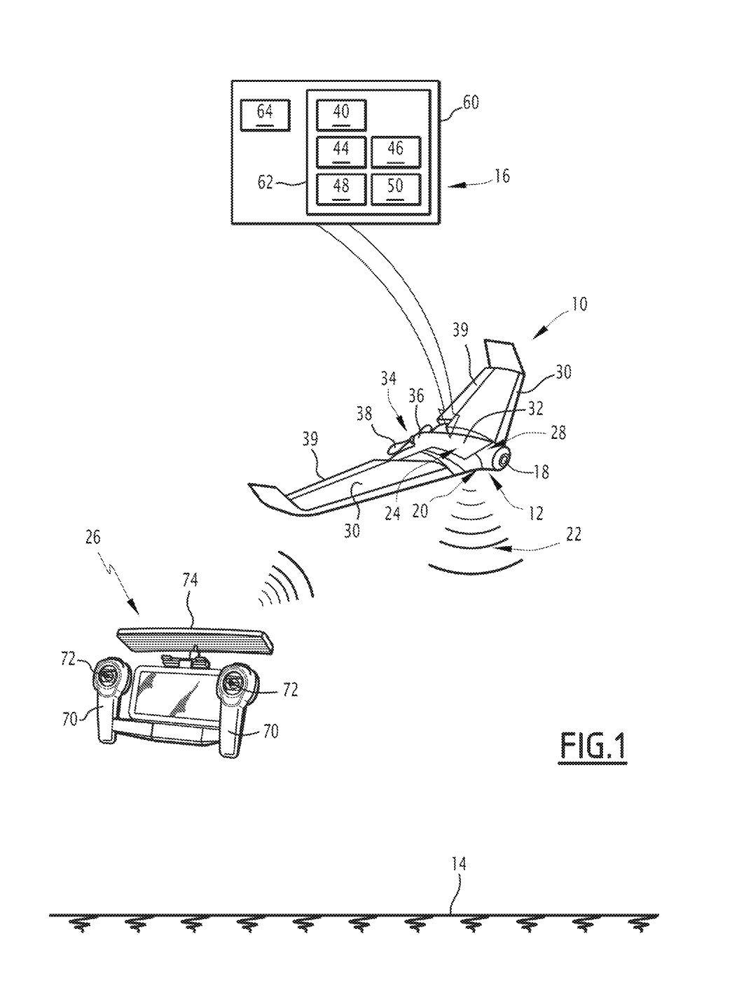

In FIG. 1, a drone 10, i.e. an unmanned aircraft comprises a first image sensor 12 that is configured for taking a succession of images of a terrain 14 overflown by the drone 10, and an electronic control device 16 configured for controlling the drone.

The drone 10 comprises a second image sensor 18 configured for taking images of a scene towards which the drone 10 is moving, the second image sensor 18 being for example a forward-facing camera.

The drone 10 also comprises an altimeter 20, such as a radioaltimeter or an ultrasonic rangefinder, emitting a beam 22 towards the ground making it possible to measure the altitude of the drone 10 with respect to the terrain 14, i.e. with respect to the ground.

The drone 10 also comprises a measuring device 24 able to measure a ground speed Vₛₒₗ_{_}ₘₑₛ of the drone 10. The measurement device 24 is, for example, a satellite positioning device, also called a GNSS (Global Navigation Satellite System) device, or an inertial unit, also called IMU (Inertial Measurement Unit) with accelerometers and/or gyrometers, for measuring angular velocities and attitude angles of the drone 10.

In optional addition, the drone 10 comprises a pressure sensor (not shown), also called barometric sensor, configured for determining variations in the altitude of the drone 10, such as instantaneous variations and/or variations with respect to a reference level, i.e. with respect to a predefined initial altitude. The reference level is, for example, sea level, and the pressure sensor is then able to provide a measured altitude of the drone 10 with respect to sea level.

In addition, the drone 10 comprises a sensor (not shown) for measuring the air speed of the drone, this measurement sensor being connected to a dynamic pressure tap of a pitot probe type element. In optional addition, the drone 10 comprises a magnetometric sensor (not shown) giving the orientation of the drone with respect to the geographical north. The drone 10 is a motorized flying machine which is remotely controllable, in particular via a joystick 26.

The drone 10 comprises a transmission module 28 configured for exchanging data, preferably by radio waves, with one or more pieces of electronic equipment, in particular with the joystick 26, or even with other electronic elements for the transmission of the acquired image(s) by the image sensors 12, 18.

In the example of FIG. 1, the drone 10 is a fixed-wing drone of the flying-wing type. It comprises two wings 30 and a fuselage 32 provided at the rear of a propulsion system 34 comprising a motor 36 and a propeller 38. Each wing 30 is provided with at least one rudder 39 that is steerable via a servomechanism (not shown) on the trailing edge side to control the trajectory of the drone 10.

Alternatively, the drone 10 is a rotary wing drone (not shown) which comprises at least one rotor, or preferably a plurality of rotors, the drone 10 being then called a multirotor drone. The number of rotors is, for example 4, and the drone 10 is then called a quadrotor drone.

The first image sensor 12 is known per se, and is, for example, a vertical-aiming camera pointing downwards.

The terrain 14 is understood in the general sense of the term, as a portion of the Earth's surface when it is an external terrain, whether it is a terrestrial surface or a maritime surface, or a surface comprising both a terrestrial portion and a maritime portion. In one variant, the terrain 14 is an interior terrain within a building. The terrain 14 is also called the ground.

The electronic control device 16 comprises a first acquisition module 40 configured for acquiring a succession of images of a terrain overflown by the drone 10, the images being taken by an image sensor fitted to the drone 10, such as the first image sensor 12, or even such as the second image sensor 18, wherein it should be understood that the images that are preferentially used for the application of the optical flow algorithm to the acquired images, are those provided by the first image sensor 12.

The electronic control device 16 comprises a second acquisition module 44 configured for acquiring the measured ground speed Vₛₒₗ_{_}ₘₑₛ, supplied by the measuring device 24 equipping the drone 10. The second acquisition module 44 is further configured for acquiring an altitude Z_{ref}_{_}ₘₑₛ of the drone 10 measured with respect to a reference level. Optionally, the second acquisition module 44 is further configured for acquiring an altitude Zₛₒₗ_{_}ₘₑₛ of the drone 10 measured with respect to the terrain 14, i.e. with respect to the ground.

The electronic control device 16 comprises a calculation module 46 configured for calculating an altitude Zₛₒₗ_{_}ₑₛₜ of the drone 10 with respect to the terrain 14, based on the acquired measured ground speed Vₛₒₗ_{_}ₘₑₛ, and an optical flow algorithm applied to the acquired images.

According to the invention, the electronic control device 16 further comprises a recalibration module 48 configured for correlating the altitude calculated with respect to the terrain Zₛₒₗ_{_}ₑₛₜ and the altitude measured with respect to the reference level Z_{ref}_{_}ₘₑₛ.

Optionally, the electronic control device 16 further comprises a control module 50 configured for controlling an attitude of the drone 10 as a function of an altitude of the drone 10, the control module 50 being configured for calculating control instructions corresponding to said attitude.

In the example of FIG. 1, the electronic control device 16 comprises an information processing unit 60, formed, for example, by a memory 62 and a processor 64 associated with the memory 62.

The joystick 26 is known per se, and allows controlling the drone 10. In the example of FIG. 1, the joystick 26 comprises two gripping handles 70 each of which is intended to be grasped by a respective hand of the operator, a plurality of control members, two joysticks 72 each of which is disposed near a respective handle 70 and intended to be actuated by the operator, preferably by a respective thumb. Alternatively (not shown), the controller 26 is implemented via a computer or electronic tablet, as known per se.

The controller 26 also includes a radio antenna 74 and a radio transceiver (not shown) for exchanging radio wave data with the drone 10, both uplink and downlink.

In the example of FIG. 1, the first acquisition module 40, the second acquisition module 44, the calculation module 46 and the recalibration module 48, as well as the optional control module 50, are each made in the form of software executable by the processor 64. The memory 62 of the information processing unit 60 is then able to store first acquisition software configured for acquiring a succession of images of a terrain overflown by the drone 10 and taken by an image sensor, such as the first image sensor 12. The memory 62 of the information processing unit 60 is able to store second acquisition software configured for acquiring the measured ground speed Vₛₒₗ_{_}ₘₑₛ, provided by the measuring device 24 equipping the drone 10, and also for acquiring the altitude Z_{ref}_{_}ₘₑₛ of the drone 10 measured with respect to the reference level. The memory 62 of the information processing unit 60 is able to store calculation software configured for calculating the altitude Zₛₒₗ_{_}ₑₛₜ of the drone 10 with respect to the terrain 14, based on the optical flow algorithm applied to the acquired images and the acquired measured ground speed Vₛₒₗ_{_}ₘₑₛ, and recalibration software configured for correlating the altitude calculated with respect to the terrain Zₛₒₗ_{_}ₑₛₜ with the altitude measured with respect to the reference level Z_{ref}_{_}ₘₑₛ. Optionally, the memory 62 of the information processing unit 60 is able to store control software configured for controlling the attitude of the drone 10 according to the altitude of the drone 10, the control software being configured for calculating flight instructions corresponding to said attitude. The processor 64 of the information processing unit 60 is then able to execute the first acquisition software, the second acquisition software, the calculation software and the recalibration software, as well as the optional additional control software.

Alternatively (not shown), the first acquisition module 40, the second acquisition module 44, the calculation module 46 and the recalibration module 48, as well as the optional control module 50, are each made in the form of a programmable logic component, such as an FPGA (Field Programmable Gate Array), or in the form of a dedicated integrated circuit, such as an ASIC (Applications Specific Integrated Circuit).

The first acquisition module 40 is further configured for calculating a first indicator Ind₁ as a function of a gradient of each acquired image, and the calculation module 46 is then further configured for calculating, only when the value of the first indicator Ind₁ is greater than a first threshold S₁, the altitude Zₛₒₗ_{_}ₑₛₜ of the drone 10 with respect to the terrain 14 by application of the optical flow algorithm to the acquired images.

The first acquisition module 40 is, for example, configured for calculating for each pixel, a gradient of intensity value between the intensity value of the pixel in question and that of the neighboring pixels, the intensity value of each pixel being, for example, expressed in gray level, for example in 8 bits with values lying between 0 and 255.

The first indicator Ind₁ is then, for example, the number of pixels of the image for which the calculated gradient is greater than a predefined minimum gradient. The first threshold S₁ is then, for example, 4, and the image is then considered to be sufficiently good for the application of the optical flow algorithm from the moment when the value of the gradient is greater than or equal to the predefined minimum gradient for at least 4 pixels of the said image.

The calculation module 46 is configured for calculating the altitude Zₛₒₗ_{_}ₑₛₜ of the drone 10 with respect to the terrain 14 based on the optical flow algorithm applied to the acquired images and the measured ground speed Vₛₒₗ_{_}ₘₑₛ acquired by the second acquisition module 44.

The optical flow algorithm is known per se, and is generally used to estimate a ground speed from a predefined altitude of the drone with respect to the terrain, this predefined altitude being assumed to be substantially constant.

The optical flow algorithm makes it possible to estimate the differential movement of a scene from one image to the next image, and there are various known methods for implementing the optical flow algorithm, such as, for example, the Lucas-Kanade method, the Horn-Schunk method, or the Farneback method. The optical flow algorithm is furthermore capable of being implemented via a so-called multi-resolution technique, which is configured for estimating the optical flow with different successive image resolutions, starting from a low resolution to a high resolution.

The optical flow algorithm is also capable of being combined with another image processing algorithm, in particular with a corner detection algorithm, to improve the estimation of the differential movement of the scene from one image to the next, as described in EP 2 400 460 A1. Other examples of the implementation of an optical flow algorithm are also described in the documents “Optic-Flow Based Control of a 46 g Quadrotor” by Briod et al, “Optical Flow Based Velocity Estimation for Vision Based Navigation of Aircraft” by Julin et al, and “Distance and velocity estimation using optical flow from a monocular camera” by Ho et al.

The calculation module 46 is configured for implementing this optical flow algorithm in an inverse manner, by assuming the known ground speed and then seeking to calculate the value of the altitude Zₛₒₗ_{_}ₑₛₜ of the drone 10 with respect to the terrain 14. The calculation module 46 is, in particular, configured for using for this purpose, as the predefined value of the ground speed, the value of the measured ground speed Vₛₒₗ_{_}ₘₑₛ, acquired by the second acquisition module 44.

The recalibration module 48 is configured for correlating the altitude calculated with respect to the terrain Zₛₒₗ_{_}ₑₛₜ and the altitude measured with respect to the reference level Z_{ref}_{_}ₘₑₛ, in order to have a more reliable value of the altitude of the drone 10 with respect to the terrain 14.

Optionally, the recalibration module 48 is configured, in particular, for estimating a current altitude Zₛₒₗ_{_}ₑₛₜ(N) with respect to the terrain 14 from a current altitude Zₛₒₗ_{_}ₑₛₜ(N) measured with respect to the reference level and a previous altitude Zₛₒₗ_{_}ₑₛₜ(N−1) calculated with respect to terrain that has been correlated with a previous altitude Zₛₒₗ_{_}ₑₛₜ(N−1) measured with respect to the reference level.

The person skilled in the art will understand that N is an integer index with a value greater than or equal to 1, designating the current value of the quantity in question, while the index N−1 then designates the previous value of the quantity in question corresponding to the last correlation performed, while the index 0 designates an initial value of the quantity in question.

The recalibration module 48 is preferably configured for estimating the current altitude with respect to the terrain Zₛₒₗ_{_}ₑₛₜ(N) from the current altitude measured with respect to the reference level Z_{ref}_{_}ₘₑₛ(N) and from the previous altitude calculated with respect to the field Zₛₒₗ_{_}ₑₛₜ(N−1) which has been correlated with the previous measured altitude with respect to the reference level Z_{ref}_{_}ₘₑₛ(N−1) in the event of an—at least temporary—failure of the calculation, based on the optical flow algorithm, of the altitude with respect to the terrain.

Optionally, the recalibration module 48 is further configured for calculating a second indicator Ind₂ inversely proportional to the first indicator Ind₁, and for correlating the calculated altitude with respect to the terrain Zₛₒₗ_{_}ₑₛₜ, the measured altitude being compared to the reference level Z_{ref}_{_}ₘₑₛ only when the value of the second indicator Ind₂ is less than a second threshold S₂. The value of the second threshold S₂ is more restrictive than the value of the first threshold S₁.

The control module 50 is configured for controlling the attitude of the drone 10. When the altitude measured with respect to the terrain Zₛₒₗ_{_}ₑₛₜ is greater than a first predefined threshold altitude Z₁, the control module 50 is configured for controlling the attitude of the drone 10 as a function of the altitude measured with respect to the terrain Zₛₒₗ_{_}ₘₑₛ, acquired by the second acquisition module 44, and preferably only as a function of this altitude Zₛₒₗ_{_}ₘₑₛ among the various altitudes mentioned above. The first predefined threshold altitude Z₁ is, for example, substantially equal to 15 m.

When the value of the altitude measured with respect to the terrain Zₛₒₗ_{_}ₘₑₛ is lower than the first predefined threshold altitude Z₁, the control module 50 is configured for controlling the attitude of the drone 10 in addition to the altitude with respect to the terrain Zₛₒₗ_{_}ₑₛₜ, which is calculated by the calculation module 46. In other words, when the value of the altitude measured with respect to the terrain Zₛₒₗ_{_}ₘₑₛ is lower than the first predefined threshold altitude Z₁, the control module 50 is configured for controlling the attitude of the drone 10 as a function of the altitude measured with respect to the terrain Zₛₒₗ_{_}ₘₑₛ and the altitude calculated with respect to the terrain Zₛₒₗ_{_}ₑₛₜ, the calculated altitude being preferably the recalibrated altitude provided at the output of the recalibration module 48.

When the value of the altitude measured with respect to the terrain Zₛₒₗ_{_}ₘₑₛ is lower than a second predefined threshold altitude Z2, the control module 50 is configured for controlling the pitch of the drone 10 to a value greater than a predefined minimum landing pitch. The second predefined threshold altitude Z2 is for example substantially equal to 1.2 m.

In other words, when the value of the altitude measured with respect to the terrain Zₛₒₗ_{_}ₘₑₛ is lower than this second predefined threshold altitude Z2 which corresponds to an altitude close to the ground, the control module 50 is configured for giving the drone 10 an emergency pitch in the event that proximity to the ground was not previously detected, and where the value of the pitch of the drone 10 was not already greater than the predefined minimum landing pitch.

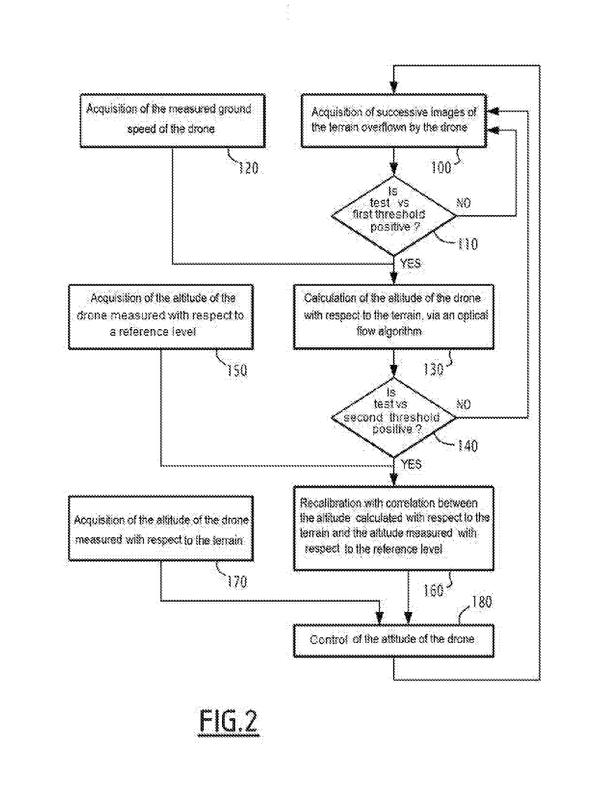

The operation of the drone 10 is, in particular the electronic control device 16 according to the invention, is now explained with the help of FIG. 2 which shows a flowchart of the determination method according to the invention.

During an initial step 100, different successive images of the terrain 14 overflown by the drone 10 are acquired by the first acquisition module 40, preferably from the first image sensor 12, such as a vertical-aiming camera pointing downwards.

Optionally, the first acquisition module 44 calculates the first indicator Ind₁ relating to these different acquired images, and which is an indicator of the quality of the images acquired. The control device 16 then tests, in the next step 110, the value of the first indicator Ind1 with respect to the first threshold S1, i.e. it compares the value of the first indicator Ind1 with that of the first threshold S1.

In parallel, during step 120, a value of the measured ground speed Vₛₒₗ_{_}ₘₑₛ is acquired by the second acquisition module 44 from the measuring device 24, this measuring device 24 being, for example, a satellite positioning device, also called a GNSS device, such as a GPS receiver or GLONASS receiver, or an inertial unit, also called IMU.

If, during step 110, the test with respect to the first threshold S1 is positive, i.e. if the value of the first indicator Ind₁ is greater than or equal to the first threshold S1, then the control device 16 passes to step 130 in which the calculation module 46 calculates the altitude Zₛₒₗ_{_}ₑₛₜ of the drone 10 with respect to the terrain 14, by application of the optical flow algorithm to the acquired images, and from the value of the measured ground speed Zₛₒₗ_{_}ₘₑₛ.

Otherwise, if the test performed in step 110 is negative, i.e. if the value of the first indicator Ind₁ is lower than the first threshold S1, then the control device 16 returns to step 100 to acquire new images of the terrain 14 overflown by the drone 10.

The optical flow algorithm used in step 130 is, for example, an optical flow algorithm using the Lucas-Kanade method.

In the next step 140, the calculation module 46 calculates the second indicator Ind2 which is inversely proportional to the first indicator Ind1, and tests this second indicator Ind2 with respect to the second threshold S2, i.e. compares this second indicator Ind₂ with the second threshold S2.

In parallel, during step 150, a value of the measured altitude with respect to the reference level Z_{ref}_{_}ₘₑₛ is acquired by the second acquisition module 44, for example from the pressure sensor, the reference level being for example sea level.

If, during step 140, the test with respect to the second threshold S2 is positive, i.e. if the value of the second indicator Ind2 is less than or equal to the second threshold S2, then the calculation module 46 transmits to the recalibration module 48 the value of the calculated altitude of the drone with respect to the terrain Zₛₒₗ_{_}ₑₛₜ, and the control device 16 passes to step 160 during which the recalibration module 48 correlates the calculated altitude with respect to the terrain Zₛₒₗ_{_}ₑₛₜ with the measured altitude with respect to the reference level Z_{ref}_{_}ₘₑₛ.

Otherwise, if the test performed in step 140 is negative, i.e. if the value of the second indicator Ind2 is greater than the second threshold S2, then the control device 16 returns to step 100 to acquire new images of the terrain 14 overflown by the drone 10.

In step 160, the recalibration module 48 estimates, in particular, the current altitude Zₛₒₗ_{_}ₑₛₜ(N) with respect to the terrain 14 from the current altitude Z_{ref}_{_}ₘₑₛ(N) measured with respect to the reference level and the previous altitude Zₛₒₗ_{_}ₑₛₜ(N−1) calculated with respect to terrain that has been correlated with the previous altitude Z_{ref}_{_}ₘₑₛ(N−1) measured with respect to the reference level. This is particularly useful in case of at least a temporary failure of the calculation of the altitude with respect to the terrain Zₛₒₗ_{_}ₑₛₜ based on the optical flow algorithm, i.e. in the case where one of the two tests with respect to the first and second thresholds S1, S2, described above, is negative.

In parallel, during step 170, a value of the altitude measured with respect to the terrain Zₛₒₗ_{_}ₘₑₛ is acquired by the second acquisition module 44 from the altimeter 20, such as a radio altimeter or an ultrasound range finder.

The control device 16 then proceeds to step 180 during which the control module 50 controls the attitude of the drone 10, in particular as a function of the altitude of the drone 10 with respect to the terrain 14. The control module 50 then calculates control instructions corresponding to the said attitude as a function of the said altitude of the drone with respect to the terrain 14, these control instructions being in particular intended for servomechanisms orienting the control surfaces 39.

For this purpose, the control module 50 is able to use the value of the altitude with respect to the terrain Zₛₒₗ_{_}ₑₛₜ calculated by the calculation module 46, and preferably the recalibrated altitude provided at the output of the recalibration module 48, and/or the value of the altitude measured with respect to the terrain Zₛₒₗ_{_}ₘₑₛ and acquired by the second acquisition module 44, as represented in FIG. 2.

More precisely, when the altitude measured with respect to the terrain Zₛₒₗ_{_}ₘₑₛ is greater than the first predefined threshold altitude Z1, the control module 50 controls, during the step 180, the attitude of the drone 10 as a function of the measured altitude with respect to the terrain Zₛₒₗ_{_}ₘₑₛ, and preferably only according to this altitude measured with respect to the terrain Zₛₒₗ_{_}ₘₑₛ among the different altitudes, measured or calculated, for the drone 10.

During step 180, when the value of the altitude measured with respect to the terrain Zₛₒₗ_{_}ₘₑₛ is lower than the first predefined threshold altitude Z1, i.e. when the drone 10 is soon likely to start its landing phase, or when the drone 10 has received a landing instruction, for example from the joystick 26, the control module 50 controls the attitude of the drone 10 as a function of the altitude measured with respect to the terrain Zₛₒₗ_{_}ₘₑₛ and the altitude calculated with respect to the terrain Zₛₒₗ_{_}ₑₛₜ, the calculated altitude being preferably the recalibrated altitude provided at the output of the recalibration module 48.

Optionally, when the value of the altitude measured with respect to the terrain Zₛₒₗ_{_}ₘₑₛ is lower than the second predefined threshold altitude Z2, the control module 50 controls, during the step 180, the pitch of the drone 10 to a minimum predefined landing pitch, in order to implement an emergency pitch in the event that pitching of the drone 10 was not previously instructed.

At the end of the step 180, the control device 16 returns to step 100 to acquire new images of the terrain 14 overflown by the drone 10.

The electronic control device 16 according to the invention then allows recalibrating the altitude of the drone calculated with respect to the terrain Zₛₒₗ_{_}ₑₛₜ, by correlating this altitude calculated with respect to the terrain Zₛₒₗ_{_}ₑₛₜ and the altitude measured with respect to the reference level Zₛₒₗ_{_}ₘₑₛ, which makes it possible to have a more reliable value of the altitude of the drone 10 with respect to the terrain 14.

This is particularly effective in case of an—at least temporary—failure of the calculation, based on the optical flow algorithm, of the altitude with respect to the terrain, and the comparison of the first and second indicators Ind1, Ind2 with the first and second thresholds S1, S2 respectively, then allows effectively detecting such a failure of the calculation of the altitude from the optical flow algorithm.

Such a failure is, for example, likely to occur when the terrain 14 overflown by the drone 10 generates a scene varying slightly from one image to another, which then generates a relatively high calculation uncertainty upon applying the optical flow algorithm to acquired images.

The altitude with respect to the terrain thus calculated and recalibrated, is then more reliable, and is particularly useful during the landing phase, in order to better predict the approach to the ground and to anticipate the time when the control device 16 has to command a pitching up of the drone 10 in order to touch the ground.

The possible need to force the pitch of the drone 10 to a predefined minimum landing pitch, when the value of the altitude measured by the altimeter 20 is less than the second predefined threshold altitude Z2, further allows providing an emergency corrective procedure for landing the drone 10, especially in the event that the recalibrated altitude provided at the output of the recalibration module 48 is temporarily disturbed.

It is then conceivable that the electronic control device 16 and the control method according to the invention allow calculating more reliably the altitude of the drone 10 with respect to the terrain overflown, and then reducing possible jerkiness during the operation of the drone 10, especially during the landing phase.

1. An electronic device for controlling a drone, wherein the device comprises:
a first acquisition module configured for acquiring a succession of images of a terrain overflown by the drone and taken by an image sensor equipping the drone;
a second acquisition module configured for acquiring a measured ground speed, provided by a measuring device equipping the drone, and for acquiring an altitude of the drone measured with respect to a reference level; and
a calculation module configured for calculating an altitude of the drone with respect to the terrain, based on the acquired ground speed and an optical flow algorithm applied to the acquired images; and
a recalibration module configured for correlating the altitude calculated with respect to the terrain with the altitude measured with respect to the reference level.

2. The electronic device according to claim 1, wherein the recalibration module is further configured for estimating a current altitude with respect to the terrain from a current altitude measured with respect to the reference level and a previous calculated altitude with respect to the terrain that has been correlated with a previous measured altitude with respect to the reference level.

3. The electronic device according to claim 2, wherein the recalibration module is configured for estimating the current altitude with respect to the terrain from the current altitude measured with respect to the reference level and the previous calculated altitude with respect to the terrain in case of a failure, at least temporary, of the calculation of the altitude with respect to the terrain based on the optical flow algorithm.

4. The electronic device according to claim 1, wherein the first acquisition module is further configured for calculating a first indicator according to an image gradient, the calculation module being configured for calculating the altitude of the drone with respect to the terrain only when the value of the first indicator is greater than a first threshold.

5. The electronic device according to claim 4, wherein the recalibration module is further configured for calculating a second indicator inversely proportional to the first indicator and for correlating the calculated altitude with respect to the terrain with the measured altitude with respect to the reference level only when the value of the second indicator is less than a second threshold.

6. The electronic device according to claim 1, wherein the reference level is sea level, and the altitude measured with respect to sea level is obtained via a pressure sensor.

7. The electronic device according to claim 1, wherein the second acquisition module is configured for further acquiring an altitude of the drone measured with respect to the terrain, and the device further comprises a control module configured for controlling an attitude of the drone as a function of an altitude of the drone, wherein the control module is configured for calculating control instructions corresponding to said attitude.

8. The electronic device according to claim 7, wherein when the value of the altitude measured with respect to the terrain is greater than a first predefined threshold altitude, the control module is configured for controlling the attitude of the drone as a function of the altitude measured with respect to the terrain, which is acquired by the second acquisition module, and
when the value of the measured altitude with respect to the terrain is lower than the first predefined threshold altitude, the control module is configured for controlling the attitude of the drone according to altitude with respect to the terrain calculated by the calculation module.

9. The electronic device according to claim 7, wherein when the value of the altitude measured with respect to the terrain is less than a second predefined threshold altitude, the control module is configured for controlling the pitch of the drone to a value greater than a predefined minimum landing pitch.

10. A drone comprising:
an image sensor configured for taking a succession of images of a terrain overflown by the drone; and
an electronic control device according to claim 1.

11. A method for controlling a drone having an image sensor, wherein the method is implemented by an electronic device and comprises:
acquiring a succession of images, taken by the image sensor, of a terrain overflown by the drone;
acquiring a measured ground speed via a measuring device equipping the drone;
calculating an altitude of the drone with respect to the terrain, based on the acquired measured ground speed and an optical flow algorithm applied to the acquired images;
acquiring an altitude of the drone measured with respect to a reference level; and
correlating the altitude calculated with respect to the terrain with the altitude measured with respect to the reference level.

12. A non-transitory computer-readable medium including a computer program comprising software instructions which, when executed by a computer, implement the method according to claim 11.
